(19) United States
(12) Patent Application Publication
(10) Pub. No.: US 2009/0052186 A1
(43) Pub. Date: Feb. 26, 2009

(54) High Power LED Lamp

(76) Inventor: Xinshen Xue, Shenzhen (CN)

Correspondence Address: GLOBAL IP SERVICES, 7285 W. Eagle Court, Winton, CA, 95388, US

(21) Appl. No.: 11/842,343

(22) Filed: Aug. 21, 2007

(51) Int. Cl. F21V 29/00

(52) U.S. Cl. 362/294; 362/373

(57) ABSTRACT

A high power LED lamp comprises a cover; a base panel; an LED mounted on the base panel which further includes an insulator; a substrate; a power supply received in the insulator; and a heat sink device disposed between the cover and substrate; wherein the insulator is engaged with the heat sink device, and both the LED and base panel are defined above the heat sink device. In accordance with the present invention, the heat created during work of the LED can be radiated rapidly via the heat sink device and thus ensuring good heat dispersion, high brightness, long life and low temperature.

### BACKGROUND OF THE INVENTION

1. Field of the Invention

The present invention relates to an LED lamp and more especially to a high power LED lamp.

2. Description of the Prior Art

LED lamps have advantages of long life, energy saving, little electricity consumption, low work voltage and good security which are used to replace conventional incandescent lamps and energy-saving lamps. The known LED lamps are designed to combine a plurality of LEDs with aid of a reflector panel to increase brightness. However, a chip of a high power LED will create a large amount of heat. The higher the power is, the larger the heat is created. If the heat cannot be radiated away in time, the LED will be damaged. Thus, the LED lamp in practice is subject to a heat radiation limit and then adopt a low supply current, other than a switching supply. Because of the poor power supply, the LED lamp cannot achieve desired brightness. It appears that how to radiate the heat is the key factor to influence the performance of the high power LED lamps.

At present, there exist many solutions of high power LED lamps. For instance, use a plurality of LED chip arrays with a reflector panel and a radiator or a fan, for ensuring high brightness and good heat radiation. Unfortunately, it has a very complex structure to bring inconvenience to manufacture and to result in high cost.

### BRIEF SUMMARY OF THE INVENTION

A primary object of the present invention is to provide a high power LED lamp which has good heat dispersion and high brightness.

To achieve the above-mentioned object, a high power LED lamp comprises a cover; a base panel; an LED mounted on the base panel which further includes an insulator; a substrate; a power supply received in the insulator; and a heat sink device disposed between the cover and substrate; wherein the insulator is engaged with the heat sink device, and both the LED and base panel are defined above the heat sink device.

Advantageously, the heat sink device is a hollow column and a projecting ring is formed on a middle portion thereof, and an outer surface of a lower portion of the heat sink device defines screw threads for engaging with the substrate.

Advantageously, the heat sink device is made of aluminum, copper, iron, graphite or other materials having good heat dispersion.

Advantageously, the LED is disposed within the cover, and the cover is a hollow sphere or cube with a lower opening.

Advantageously, a shape of an upper portion of the heat sink device is corresponding to the lower opening.

Advantageously, the insulator is a hollow rubber and is arranged between the heat sink device and the power supply.

Advantageously, the power supply is a switching power supply.

Advantageously, the insulator is a rubber holder and forms a loop piece on an upper portion thereof which has a shape corresponding to a lower portion of the heat sink device.

Advantageously, an outer surface of a lower portion of the insulator defines screw threads for engaging with the substrate.

Advantageously, the insulator is disposed under the heat sink device and is fastened or adhered thereto.

In accordance with the present invention, a heat sink device is disposed between the cover and the substrate and the power supply, the insulator and the LED are combined together, so that the heat created during work of the LED can be radiated rapidly via the heat sink device and thus ensuring good heat dispersion, high brightness, long life and low temperature.

Other objects, advantages and novel features of the present invention will become more apparent from the following detailed description when taken in conjunction with the accompanying drawings, in which:

### BRIEF DESCRIPTION OF THE DRAWINGS

FIG. 1 is an exploded perspective view of a high power LED lamp in accordance with a first embodiment of the present invention;

FIG. 2 is an assembly perspective view of the high power LED lamp in accordance with the first embodiment of the present invention;

FIG. 3 is an exploded perspective view of a high power LED lamp in accordance with a second embodiment of the present invention; and

FIG. 4 is an assembly perspective view of the high power LED lamp in accordance with the second embodiment of the present invention

### DETAILED DESCRIPTION OF THE INVENTION

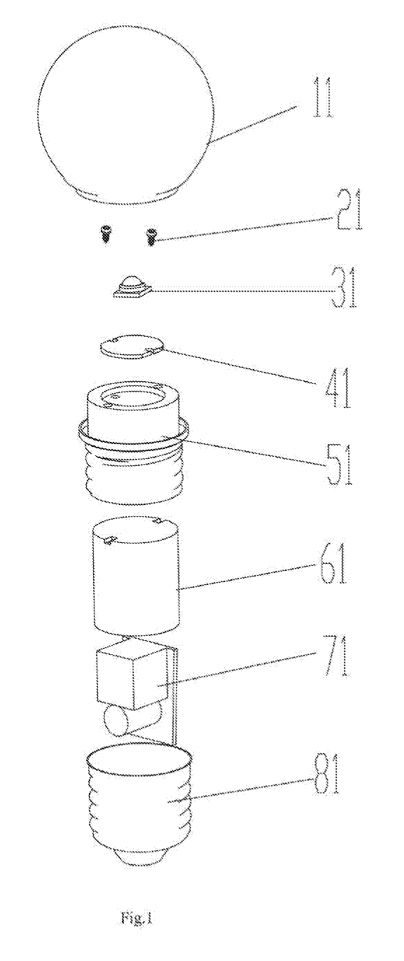

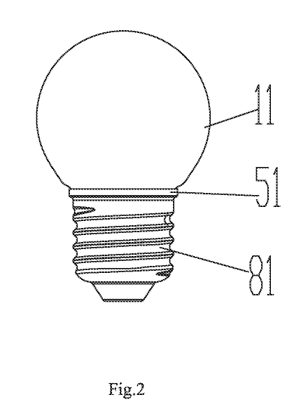

Referring to FIG. 1 and FIG. 2, in a first embodiment of the present invention, a high power LED lamp includes a cover 11, an LED 31, a base panel 41, a power supply 71, a substrate 81 and a heat sink device 51. The heat sink device 51 is defined between the cover 11 and the substrate 81. The LED 31 is formed on the base panel 41. The LED 31 further includes an insulator 61 engaged with the heat sink device 51. In this embodiment, the insulator 61 is received in the heat sink device 51 and the power supply 71 is defined in the insulator 61. Both the LED 31 and the base panel 41 are arranged above the heat sink device 51.

In this embodiment the power supply 71 is a switching power supply which can directly connect to commercial power, so as to overcome the shortcoming of poor brightness caused by the low power supply.

The heat sink device 51 is made of aluminum, copper, iron, graphite or other materials having good heat dispersion. The heat sink device 51 is a hollow column and a projecting ring is formed on a middle portion thereof. An outer surface of a lower portion of the heat sink device 51 defines screw threads for engaging with the substrate 81. An upper portion of the heat sink device 51 is engaged with a bottom portion of the cover 11. In this embodiment the upper portion, lower portion and the projecting ring all have a cross section of circular ring, triangle, rectangle, pentagon or other polygon.

The insulator 61 is a hollow rubber which has a cross section of circular ring, triangle, rectangle, pentagon or other polygon. The insulator 61 is arranged between the heat sink device 51 and the power supply 71 to achieve the effect of insulation. The LED 31, the base panel 41 and the insulator 61 are mounted together by bolts 21. The power supply 71 electrically connects with the LED 31 by wires. Through the combination of the cover 11, the heat sink device 51, the LED 31, the power supply 71 and the insulator 61, the heat created during work of the LED 31 can be radiated rapidly via the heat sink device 51, so as to ensure good heat dispersion and high brightness.

The LED 31 is disposed within the cover 11. The cover 11 can be a hollow sphere or cube with a lower opening. The shape of the upper portion of heat sink device 51 is corresponding to the lower opening of the cover 11 for engaging together. The cover 11 is made of transparent materials just like glass or polymethyl methacrylate with sand blasting and powder spraying for various lighting effects.

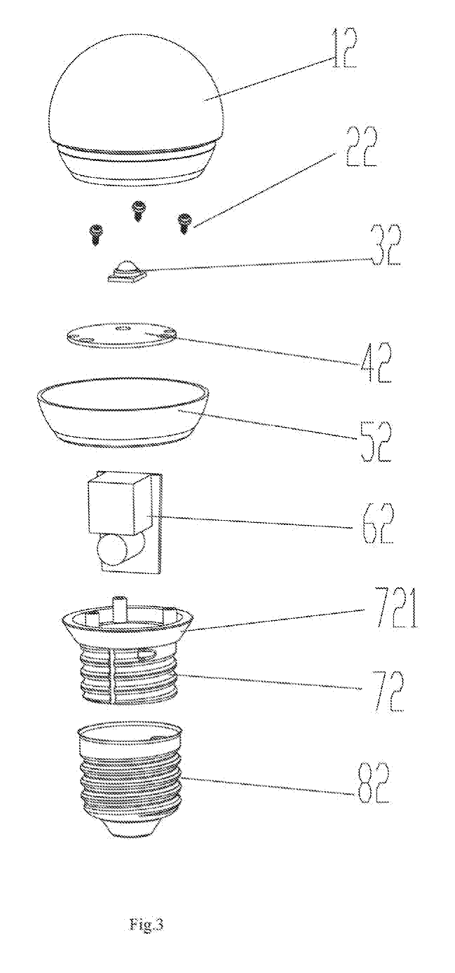

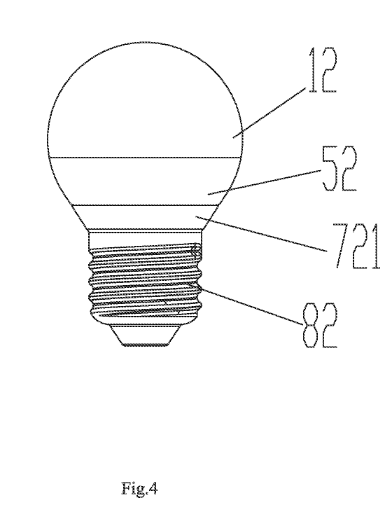

Referring to FIG. 3 and FIG. 4, in a second embodiment of the present invention, a high power LED lamp includes a cover 12, an LED 32, a base panel 42, a power supply 62, a substrate 82 and a heat sink device 52. The heat sink device 52 is defined between the cover 12 and the substrate 82. The LED 32 is formed on the base panel 42. The LED 32 further includes an insulator 72 engaged with the heat sink device 52. In this embodiment, the insulator 72 is disposed under the heat sink device 52 and is fastened or adhered thereto. The power supply 62 is defined in the insulator 72. Both the LED 32 and the base panel 42 are arranged above the heat sink device 52.

In this embodiment the power supply 62 is a switching power supply which can directly connect to commercial power, so as to overcome the shortcoming of poor brightness caused by the low power supply.

The heat sink device 52 is made of aluminum, copper, iron, graphite or other materials having good heat dispersion. The heat sink device 52 is a hollow column having a cross section of circular ring, triangle, rectangle, pentagon or other polygon.

In this embodiment, the insulator 72 is a rubber holder. The insulator 72 forms a loop piece 721 on an upper portion of the insulator 72 of which the shape is corresponding to a lower portion of the heat sink device 52. An outer surface of a lower portion of the insulator 72 defines screw threads for engaging with the substrate 82. The heat sink device 52 is fastened or adhered to the cover 12. The power supply 62 electrically connects with the LED 32 by wires. The heat created during work of the LED 32 can be radiated rapidly via the heat sink device 52, so as to ensure good heat dispersion and high brightness. The high power LED lamps of 3-5 watt in accordance with the present invention is absolutely available to replace the conventional incandescent lamps and energy-saving lamps.

In this embodiment, the LED 32 is disposed within the cover 12. The cover 12 can be a hollow sphere or cube with a lower opening. The shape of the upper portion of heat sink device 52 is corresponding to the lower opening of the cover 12 for engaging together. The cover 12 is made of transparent materials just like glass or polymethyl methacrylate with sand blasting and powder spraying for various lighting effects.

In accordance with the present invention, a heat sink device is disposed between the cover and the substrate and the power supply, the insulator and the LED are combined together, so that the heat created during work of the LED can be radiated rapidly via the heat sink device and thus ensuring good heat dispersion, high brightness, long life and low temperature.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A high power LED lamp comprising:
a cover;
a base panel;
an LED mounted on said base panel which further includes an insulator;
a substrate;
a power supply received in said insulator; and
a heat sink device disposed between said cover and substrate;
wherein said insulator is engaged with said heat sink device, and both said LED and base panel are defined above said heat sink device.

2. The high power LED lamp as claimed in claim 1, wherein said heat sink device is a hollow column and a projecting ring is formed on a middle portion thereof, and an outer surface of a lower portion of said heat sink device defines screw threads for engaging with said substrate.

3. The high power LED lamp as claimed in claim 1, wherein said heat sink device is made of aluminum, copper, iron, graphite or other materials having good heat dispersion.

4. The high power LED lamp as claimed in claim 1, wherein said LED is disposed within said cover, and said cover is a hollow sphere or cube with a lower opening.

5. The high power LED lamp as claimed in claim 4, wherein a shape of an upper portion of said heat sink device is corresponding to the lower opening of said cover.

6. The high power LED lamp as claimed in claim 1, wherein said insulator is a hollow rubber and is arranged between said heat sink device and said power supply.

7. The high power LED lamp as claimed in claim 1, wherein said power supply is a switching power supply.

8. The high power LED lamp as claimed in claim 1, wherein said insulator is a rubber holder and forms a loop piece on an upper portion thereof which has a shape corresponding to a lower portion of said heat sink device.

9. The high power LED lamp as claimed in claim 1, wherein an outer surface of a lower portion of said insulator defines screw threads for engaging with said substrate.

10. The high power LED lamp as claimed in claim 1, wherein said insulator is disposed under said heat sink device and is fastened or adhered thereto.

11. A high power LED lamp comprising:
a cover;
a base panel;
an LED mounted on said base panel which further includes an insulator;
a substrate;
a power supply received in said insulator; and
means for radiating heat created by said LED when work which is disposed between said cover and substrate;
wherein said insulator is engaged with said means, and both said LED and base panel are defined above said means.

12. The high power LED lamp as claimed in claim 11, wherein said means is made of aluminum, copper, iron, graphite or other materials having good heat dispersion.

13. A high power LED lamp comprising:
a housing;
an LED received in said housing which further includes an insulator;
a power supply received in said insulator; and
a heat sink device;
wherein said insulator is engaged with said heat sink device, and said LED is defined above said heat sink device.

14. The high power LED lamp as claimed in claim 13, wherein said housing includes a cover and a substrate, said heat sink device is disposed between said cover and substrate.

15. The high power LED lamp as claimed in claim 14, wherein said heat sink device is a hollow column and a projecting ring is formed on a middle portion thereof, and an outer surface of a lower portion of said heat sink device defines screw threads for engaging with said substrate.

16. The high power LED lamp as claimed in claim 13, wherein said heat sink device is made of aluminum, copper, iron, graphite or other materials having good heat dispersion.

17. The high power LED lamp as claimed in claim 14, wherein said LED is disposed within said cover, and said cover is a hollow sphere or cube with a lower opening.

18. The high power LED lamp as claimed in claim 17, wherein a shape of an upper portion of said heat sink device is corresponding to said lower opening.

19. The high power LED lamp as claimed in claim 13, wherein said insulator is a hollow rubber and is arranged between said heat sink device and said power supply.

20. The high power LED lamp as claimed in claim 13, wherein said power supply is a switching power supply.
